(19) United States
(12) Patent Application Publication
(10) Pub. No.: US 2024/0210367 A1
(43) Pub. Date: Jun. 27, 2024

(54) PROCESS, USE OF AN INDICATOR MATERIAL AND APPARATUS FOR DETERMINING A CONDITION OF A HYDROGEN CARRIER MATERIAL

(71) Applicant: HYDROGENIOUS LOHC TECHNOLOGIES GMBH, Erlangen (DE)

(72) Inventors: Alexander WEISS, Möhrendorf (DE); Alexander SEIDEL, Erlangen (DE); Caspar PAETZ, Erlangen (DE); Jonas OBERMEIER, Erlangen (DE); Holger BÜCH, Erlangen (DE)

(21) Appl. No.: 18/555,976

(22) PCT Filed: Apr. 14, 2022
(86) PCT No.: PCT/EP2022/060064

§ 371 Date: Oct. 18, 2023

(30) Foreign Application Priority Data
Apr. 19, 2021 (DE) 10 2021 203 886.7

(51) Int. Cl. G01N 31/22; C01B 3/00

(52) U.S. Cl. CPC G01N 31/22; C01B 3/0015

(57) ABSTRACT

A method for determining a state of a hydrogen carrier material comprises using the hydrogen carrier material in a cyclic storage process, wherein each storage cycle comprises charging the hydrogen carrier material with hydrogen, releasing hydrogen from the hydrogen carrier material and producing a mixture by adding a defined amount of an indicator material to the hydrogen carrier material. Further, determining a proportion of the indicator material in the mixture and determining a number of storage cycles for the hydrogen carrier material on the basis of the determined proportion of the indicator material and/or a degradation of the hydrogen carrier material on the basis of the determined proportion of the indicator material as a state of the hydrogen carrier material are provided.

### CROSS-REFERENCES TO RELATED APPLICATIONS

This application claims the priority of German Patent Application, Serial No. 10 2021 203 886.7, filed 19 Apr. 2021, the content of which is incorporated herein by reference in its entirety as if fully set forth herein.

### FIELD OF THE INVENTION

The invention relates to a method, use of an indicator material and a system for determining a state of a hydrogen carrier material.

### BACKGROUND OF THE INVENTION

U.S. Pat. No. 9,783,754 B2 discloses a method of handling a hydrogen carrier material that can be cyclically charged and discharged with hydrogen. Over its lifetime, the hydrogen carrier material may accumulate impurities, so-called contaminants, in the hydrogen carrier material. Based on the amount of impurities present, the hydrogen carrier material is defined as unusable and must be replaced.

US 2004/0223907 A1 discloses hydrogen storage by reversible hydrogenation of pi-conjugated substrates. US 2006/0226050 A1 discloses a method and a system for providing a substance contained in a carrier material.

### SUMMARY OF THE INVENTION

It is an object of the invention to improve and, in particular, to simplify the handling of a hydrogen carrier material.

This object is achieved according to the invention by a method for determining a state of a hydrogen carrier material comprising the steps of,
using the hydrogen carrier material in a cyclic storage process, wherein each storage cycle comprises
   charging the hydrogen carrier material with hydrogen,
   releasing hydrogen from the hydrogen carrier material,
   producing a mixture by adding a defined amount of an indicator material to the hydrogen carrier material,
determining a proportion of the indicator material in the mixture,
determining the state of the hydrogen carrier material to be
a number of storage cycles for the hydrogen carrier material on the basis of the determined proportion of the indicator material and/or
a degradation of the hydrogen carrier material on the basis of the determined proportion of the indicator material.

This object is further achieved by using a hydrogen carrier material as an indicator material for determining a state of a further hydrogen carrier material, in particular its number of storage cycles and/or its degradation, by using an indicator material formed by a selective conversion of a hydrogen carrier material for determining a state of the hydrogen carrier material, in particular its number of storage cycles and/or its degradation or by using an indicator material formed as a by-product, in particular of a dehydrogenation reaction of hydrogen carrier material, for determining a state of the hydrogen carrier material, in particular its number of storage cycles and/or its degradation.

This object is further achieved by a system for determining a state of a hydrogen carrier material comprising,
a charging unit for charging the hydrogen carrier material with hydrogen,
a discharging unit for releasing hydrogen from the hydrogen carrier material,
a mixing unit for producing a mixture by adding a defined amount of an indicator material to the hydrogen carrier material,
a determination unit for determining a proportion of the indicator material in the mixture,
an analysis unit for determining, as a state of the hydrogen carrier material, a number of storage cycles for the hydrogen carrier material on the basis of the determined proportion of the indicator material and/or a degradation of the hydrogen carrier material on the basis of the determined proportion of the indicator material.

The essence of the invention is that a state of a hydrogen carrier material, in particular the age of the hydrogen carrier material, can be determined in a simplified manner. The age of the hydrogen carrier material is understood in particular as the number of storage cycles for which the hydrogen carrier material has already been used. A storage cycle comprises the charging of the hydrogen carrier material with hydrogen and the release of hydrogen from the hydrogen carrier material.

It has surprisingly been found that the age of the hydrogen carrier material can be directly determined by adding a defined amount of an indicator material to the hydrogen carrier material. The amount here is understood to be the mass-related concentration of the indicator material. A mixture is produced which comprises the hydrogen carrier material and the additional amount of the indicator material. The defined amount is determined in particular in relation to the amount of the hydrogen carrier material. However, it is conceivable that the defined amount of the indicator material can be variably set. It is advantageous if the defined amount of the indicator material is identical for each storage cycle.

It has been found that the indicator material is advantageously suitable for indexing the hydrogen carrier material. In particular, it has been found that the indicator material remains substantially and in particular completely present through the charging reaction and the release reaction. In particular, the indicator material is not decomposed by the charging reaction and/or the release reaction. The amount of indicator material remains unchanged by the charging and release cycle. In particular, it has been found that the indicator material hardly, and in particular not, degrades during the storage cycle. The indicator material is accumulated over several storage cycles.

In order to determine the state of the hydrogen carrier material, in particular its age, a proportion of the indicator material in the mixture is determined, in particular measured. From the determined proportion of the indicator material in the mixture, the number of storage cycles for which the hydrogen carrier material has already been used can be determined directly. The number of storage cycles for the hydrogen carrier material is in particular at least five, in particular at least ten, in particular at least twenty-five, in particular at least fifty, in particular at least seventy and in particular at least one hundred.

The method according to the invention is uncomplicated and direct. Complicated procedures for determining contamination are unnecessary. The defined amount of indicator material added per storage cycle is referred to as Δc_{T,i}. The indicator material is also referred to as tracer material because it can be traced in the hydrogen carrier material in particular.

The total proportion of indicator material in the mixture is referred to as c_{T}. The total proportion is given by:

$${c}_{T} = {\sum }_{i} Δ {c}_{T , i}$$

Accordingly, the number of cycles i, i.e. the number of storage cycles, is given by:

$$i = \frac{{c}_{T}}{Δ {c}_{T , i}}$$

It is advantageous if the amount of indicator material Δc_{T,i} added per storage cycle is constant. In this case, the effort for the determination of numbers of cycles is reduced. In particular, it is possible to determine the number of storage cycles for the hydrogen carrier material under investigation with a single, one-off measurement.

However, it is also possible to carry out the determination of the number of cycles repeatedly, in particular after each storage cycle. This method is particularly advantageous if the amount of indicator material added per storage cycle changes.

It is essential that the indicator material differs from the hydrogen carrier material so that the proportion of indicator material in the mixture can be reliably and in particular easily determined by means of a determination method and/or a measuring method.

The hydrogen carrier material is in particular a liquid organic hydrogen carrier, LOHC for short. In particular, a hydrocarbon compound, in particular without heteroatoms, serves as the hydrogen carrier material. In particular, the hydrogen carrier material in the at least partially discharged form is diphenylmethane, benzyltoluene (BT), dibenzyl toluene (DBT), methylfluorene, fluorene, phenyltoluene, naphthalene, anthracene, ethyl-diphenylmethane, biphenyl, ethylbiphenyl, diethylbiphenyl, ethylbenzene, diethylbenzene and/or completely or partially hydrogenated compounds thereof, in particular from at least one isomer of the compounds mentioned. In particular, any random mixture of the above-mentioned hydrogen carrier materials may be used. A mixture of biphenyl and diphenylmethane, in particular in a ratio of 30:70, has been found to be advantageous. It has been found that by admixing biphenyl to diphenylmethane, a eutectic mixture with a reduced melting point can be produced which is particularly advantageous relative to the melting points of the pure substances. Biphenyl has a melting point of about 69° C. and diphenylmethane of about 26° C. The above-mentioned 30:70 mixture is still in a liquid state at a temperature of 15° C. This results in a wide range of applications as a liquid hydrogen carrier material for this mixture. In particular, the pumpability of the hydrogen carrier material remains guaranteed even at cold ambient temperatures without additional energy input, for example by heating tanks and/or pipelines. In addition, biphenyl has been found to have a high hydrogen storage capacity of 7.3% by weight.

The defined amount of indicator material can be added in particular by means of a dosing pump. The dosing pump is in particular a component of a mixing unit which serves to produce the mixture. The indicator material can be added to the at least partially charged hydrogen carrier material and/or the at least partially discharged hydrogen carrier material, i.e. before dehydrogenation and/or before hydrogenation.

It is possible that the indicator material is associated with a defined hydrogen isotope. In particular, the indicator material is characterized by a defined mixture of the hydrogen isotopes ²H/¹H. For example, the ratio ²H/¹H for hydrogen produced by electrolysis of water is between 20 and 40 μmol (²H)/mol (¹H). Hydrogen produced by steam reforming of methane has a ratio value of about 120 to 135 μmol (²H)/mol (¹H).

The isotope ratio can be measured using a mass spectrometer.

Additionally or alternatively, the state of the hydrogen carrier material may also be its degradation. In particular, it has been found that for the determination of the degradation of the hydrogen carrier material, a proportion of a by-product can be detected, wherein this by-product has been formed during the charging and/or release of the hydrogen carrier material. This is based on the finding that, in particular before and after the charging and release of the hydrogen carrier material, the proportion of the by-product and, by the difference, the rate of the by-product formed in this cycle can be determined, in particular directly. In particular, it has been recognized that an additional indicator material, which is in particular different from the hydrogen carrier material, is dispensable for the determination of the degradation of the hydrogen carrier material. In particular, the determination of the degradation can be performed without the use of a separate indicator material. The by-product formed during the charging and/or release reaction acts as an indicator material and is an indicator material in accordance with the invention.

A method, in which the indicator material is added during and/or after releasing and in particular before charging of the hydrogen carrier material, ensures the defined production of the mixture. In particular, the indicator material is added at least once per storage cycle and in particular exactly once.

A method, in which an averaged proportion of the indicator material is determined for a mixture of different batches of the hydrogen carrier material, in particular by means of exactly one measurement of the averaged proportion of the indicator material, enables the number of cycles of a hydrogen carrier material to be determined, in particular also when the mixture comprises hydrogen carrier material from different batches. For each batch of the hydrogen carrier material, the number of cycles may be different, so that an unambiguous determination of the number of storage cycles from the determined proportion of the indicator material is not possible. LOHC batches of different numbers of cycles are generated, for example, in particular unintentionally, during transport and/or storage in containers. In particular, it has been found that quantification of the individual LOHC mass fractions prior to mixing need not necessarily be determined in order to be able to determine the averaged number of cycles. It has been found that an averaged number of cycles can be determined from the averaged proportion of indicator material c̅_̅{̅T̅}̅. The averaged proportion of the indicator material c̅_̅{̅T̅}̅ can be measured in an uncomplicated manner and in particular directly in such a mixed batch. In particular, it has been found that a calculation of the averaged proportion by a function weighted with the mass fractions of the different batches and in particular the elaborate determination of mass fractions of different batches are dispensable. The calculation formula required for this is:

$$\overline{{c}_{T}} = \frac{{Σ}_{n} {c}_{T , n} \cdot {m}_{L O H C , n}}{{Σ}_{n} {m}_{L O HC , n}}$$

Where n is the number of different LOHC batches. Accordingly, the averaged number of cycles can be calculated as

$$\overline{l} = \frac{{Σ}_{n} {i}_{n} {m}_{L OHC , n}}{{Σ}_{n} {m}_{L OHC , n}} .$$

By direct measurement of the proportion of the indicator material, the number of cycles can be directly and immediately calculated as

$$\overline{l} = \frac{\overline{{c}_{T}}}{Δ {c}_{T , i}} .$$

Exactly one measurement to determine the degradation rate and/or the number of cycles is particularly easy and uncomplicated to carry out. A so-called batch tracking for mixed batches is unnecessary due to the determination of average numbers of cycles.

A method, in which the added amount (Δc_{T,i}) of indicator material per storage cycle is at most 2.0% relative to the hydrogen carrier material, in particular at most 0.5% and in particular at most 0.05%, guarantees a comparatively low proportion of the indicator material in the mixture, in particular also at a higher number of cycles.

In particular, it is ensured that the proportion of the indicator material in the mixture is smaller than the proportion of the hydrogen carrier material.

A method, in which a second hydrogen carrier material different from the hydrogen carrier material is added as indicator material, which is in particular a substrate of cyclic hydrocarbon compounds, in particular of dibenzyltoluene, benzyltoluene, toluene, N-ethylcarbazole, fluorene, methylfluorene, naphthalene, anthracene, diphenylmethane, biphenyl and/or indoline and/or mixtures of these hydrocarbon compounds, and/or completely or partially hydrogenated compounds thereof, in particular of at least one isomer of the said compounds, allows the additional use of the indicator material as hydrogen carrier material. In particular, it has been found that as the number of cycles increases, the proportion of the indicator material in the mixture rises. In order not to impair the efficiency of the charging and discharging process, in particular the storage capacity of the mixture of hydrogen carrier material and indicator material, it is advantageous if the indicator material itself can be charged and discharged with hydrogen. In particular, a second hydrogen carrier material that is different from the hydrogen carrier material in the mixture serves as the indicator material. By using a second hydrogen carrier material as indicator material, the hydrogen storage density of the mixture is increased. The separation of the indicator material, which in particular has high-boiling molecules, is simplified, in particular the preparation of the mixture when a maximum concentration of the indicator material is reached.

In particular, the indicator material has a high hydrogen storage density. In particular, the indicator material can be a hydrogen carrier material which, as a pure substance, is not liquid and, in particular, is solid or gaseous. Such a hydrogen carrier material is limited in terms of its technical use as a hydrogen carrier. It is advantageous in particular that such an indicator material, which in particular has comparatively large molecules, can be separated advantageously, in particular in an uncomplicated manner and in particular can be separated from the hydrogen carrier material in an uncomplicated manner due to its physiochemical properties. Such a separation may be necessary, for example, when an upper limit of the indicator material is reached and/or purification of the hydrogen carrier material is required. Such an indicator material with high hydrogen storage density is benzyltoluene, dibenzyltoluene, diphenylmethane, biphenyl, anthracene, naphthalene or a mixture of several of these components. The indicator material has in particular a hydrogen storage density which is greater than or equal to that of the hydrogen carrier material, wherein the hydrogen storage density is in particular at least 6% by weight.

A method, in which the indicator material is formed by a chemical reaction, in particular during a storage cycle, enables the number of cycles to be determined while the total amount of the mixture remains substantially unchanged. The indicator material is formed by a chemical reaction, in particular during the storage cycle, from the hydrogen carrier material and/or from the indicator material, in particular directly. In particular, it has been found that it is possible to carry out the chemical reactions of the storage cycle, i.e. in particular the charging, a catalytic hydrogenation reaction, and the release, a catalytic dehydrogenation reaction, in such a manner, in particular in a controlled manner, that a defined amount of indicator material is formed with each storage cycle.

It has thus been found in particular that it is not necessary to add the indicator material in a targeted manner and separately, but to use products and/or substances, in particular by-products, which are formed during the hydrogenation reaction and/or during the dehydrogenation reaction, in particular anyway, as indicator material. In particular, it has been found that the formation of by-products can be used in a targeted manner for the determination of the state of the hydrogen carrier material, in particular by determining the concentration of one or more by-products. In particular, the degradation rate of the hydrogen carrier medium can also be determined in this manner.

In particular, it has been found that the proportion of the by-product in the mixture can be understood as an indicator material in the sense of the invention. The by-product serves as an indicator material and thus directly for determining the number of storage cycles as a state for the hydrogen carrier material. Accordingly, the determination of the number of storage cycles is carried out on the basis of the proportion of the by-product.

The catalytic hydrogenation reaction takes place in particular at a process pressure between 5 barg and 50 barg, in particular between 10 barg and 40 barg and in particular between 15 barg and 30 barg, and at process temperatures between 100° C. and 350° C., in particular between 120° C. and 300° C. and in particular between 150° C. and 270° C. The hydrogenation catalyst is in particular a metal, in particular a noble metal, which is carried on a catalyst carrier material. The catalyst carrier material is in particular a metal oxide, a metal hydride and/or a metal hydroxide. The noble metal is in particular platinum, ruthenium, palladium, iridium, gold, silver, rhenium, rhodium, copper, nickel, cobalt, iron, manganese, chromium, molybdenum and/or vanadium. Mixed-metal hydrogenation catalysts and/or bimetallic hydrogenation catalysts comprising platinum and palladium have proven to be particularly advantageous, in particular in elemental form and/or in oxidic form. Aluminium oxide in particular serves as the catalyst carrier.

The dehydrogenation reaction takes place in particular at a process pressure of 0 barg and 5 barg, in particular 0.2 barg to 3 barg and in particular between 0.5 barg and 2 barg as well as at process temperatures between 200° C. and 300° C., in particular between 220° C. and 330° C. and in particular between 250° C. and 320° C. The dehydrogenation catalyst is a metallic catalyst material, which in particular has sulphur added, i.e. is sulphidized. The metallic catalyst material can also be sulphur-free, i.e. not sulphidized. In particular, platinum, palladium, nickel, rhodium and/or ruthenium serve as the metal. In particular, it has been found that selective dehydrogenation is improved when the dehydrogenation catalyst has a metal/sulphur atomic ratio of 1:1 to 1:10, in particular 1:1.5 to 1:5 and in particular 1:1.5 to 1:2.5 and in particular of 1:2. The catalyst material for the dehydrogenation catalyst is in particular arranged on a catalyst carrier and in particular attached thereto. The catalyst carrier is in particular aluminium oxide, silicon oxide, silicon carbide and/or activated carbon. The material of the catalyst carrier is in particular inert, i.e. does not participate in the dehydrogenation reaction. The proportion by weight of the catalyst material relative to the material of the catalyst carrier is in a range between 0.1% and 10%, in particular between 0.2% and 8% and in particular between 0.5% and 5%.

A method, in which the indicator material is formed by a selective conversion of the hydrogen carrier material, in particular a dehydrocyclization of the hydrogen carrier material, in particular a dehydrogenation of benzyltoluene to methylfluorene, is uncomplicated in its implementation, since dehydrogenation of the second hydrogen carrier material takes place in particular during the release reaction. The conditions for the dehydrogenation of the second hydrogen carrier material are thereby favoured and in particular can be carried out without additional measures. The use of methyl fluorene as the second hydrogen carrier material for the indicator material has proven to be particularly advantageous. Benzyltoluene can advantageously be dehydrogenated to form methylfluorene. Methylfluorene can be formed from benzyltoluene in a defined and in particular controlled manner.

A method comprising the use of a heterogeneous catalyst enables a controlled and targeted formation of the amount of the indicator material. A heterogeneous catalyst causes the chemical reaction to form the indicator material to occur in a targeted manner. In particular, the heterogeneous catalyst is part of a bed of a catalyst material in a reactor used for hydrogenating and/or dehydrogenating the hydrogen carrier material. In particular, all of the catalyst material in the hydrogenation reactor and/or dehydrogenation reactor is configured as a heterogeneous catalyst. A heterogeneous catalyst is understood to mean a solid catalyst comprising in particular porous materials, in particular noble metals such as platinum, palladium and/or ruthenium, which are carried on a porous carrier material such as aluminium oxide, silicon dioxide and/or activated carbon.

Homogeneous catalysts are dissolved in the liquid phase of the hydrogen carrier material.

A method, in which the indicator material is formed as a by-product of a chemical reaction, in particular the dehydrogenation reaction of the hydrogen carrier material, is based on the finding that the chemical reactions during a storage cycle form by-products that can advantageously be used as indicator material. In particular, it has been found that higher-boiling by-products are suitable for use as indicator material. In particular, the higher-boiling by-products remain in the liquid phase and, in particular, are not discharged via the gas phase with the released hydrogen gas during dehydrogenation. For example, methyl fluorene is higher boiling compared to benzyl toluene or dibenzyl toluene compared to benzyl toluene. Due to the physiochemical properties, i.e. in particular due to the higher boiling point, the higher-boiling by-products can be separated from the hydrogen carrier material in an uncomplicated and, in particular, inexpensive manner.

The additional effort, in particular for forming and/or adding an indicator material, is dispensable. The overall procedure is thus simplified.

In particular, it has been found that the reaction conditions during the storage cycle can be defined in particular in such a manner that the proportion of by-products per storage cycle can be adjusted in a targeted manner. The concentration of by-products Δc_{NP} formed per storage cycle thus corresponds to the defined amount of the indicator material. Δc_{T,i}. Accordingly, the total proportion of by-products c_{NP} is determined from the sum of the defined quantities per storage cycle. Accordingly, the number of storage cycles results in

$$i = \frac{{c}_{N P}}{Δ {c}_{NP , i}}$$

A method, comprising determining a proportion of a by-product in the mixture by means of a determination unit, wherein in particular during the release of hydrogen from the hydrogen carrier material a proportion of the by-product is formed for each storage cycle, wherein said proportion is in particular constant per cycle, enables immediate and direct quantification of proportions of by-products in the hydrogen carrier material.

It is particularly advantageous if the by-product formed is determined for the determination of the degradation and additionally taken into account on the basis of an indicator material.

A method, in which for determining the degradation of the hydrogen carrier material on the basis of the determined proportion of the by-product, a comparison is made with an admissible maximum value of the proportion of the by-product per storage cycle, enables, in addition to the determination of the number of cycles, also the determination of a quality of the hydrogen carrier material. In particular, the proportion of by-products formed in the hydrogen carrier material during the storage cycles serves as a quality criterion. In particular, it is conceivable to compare the determined proportion of the by-product per storage cycle with a permissible maximum value. In particular, it has been found that exceeding a permissible maximum value c_{NP,max} can have a negative effect on the storage cycle and in particular on the release and/or charging of the hydrogen carrier material. However, it has been found that in this case it is not necessary to replace the hydrogen carrier material. In particular, it is possible to reduce the proportion of by-products, in particular by means of purification, in particular distillation.

In particular, it has also been found that, in addition or as an alternative to a maximum permissible value, the incremental increase of the by-product concentration per storage cycle Δc_{NP,max} can be problematic for the quality of the hydrogen carrier material. It is advantageous to monitor the incremental increase in by-product concentration per storage cycle. In particular, it has been found that the change in by-product concentration Δc_{NP,i} is not directly measurable. Therefore, it is advantageous to measure the concentration of the by-products before a method step and after a method step, i.e. in particular before the dehydrogenation reaction and after the dehydrogenation reaction, and to determine the incremental increase of the by-product concentration from the difference:

$$Δ {c}_{N P , i} = {c}_{N P , i} - {c}_{N P , i - 1}$$

In particular, it has been found that the quotient of the incremental increase of the indicator material, i.e. the added defined amount of indicator material Δc_{T,i} and the incremental increase of the by-product concentration Δc_{NP,i} is constant, if the quality requirements are adhered to within the storage cycle. A particular advantage of the method is therefore that the total proportion of indicator material c_{T} and the total proportion of by-products (c_{NP}) form a ratio that is comparable to the quotient mentioned above. In this respect, this quotient serves to monitor the quality of the method and in particular of the hydrogen carrier material. Insofar, it is sufficient to measure the total proportion c_{T} and c_{NP} in each case during a current storage cycle, to calculate the ratio and to compare it with the quotient, which represents a setpoint value for quality monitoring. In case of a deviation of the measured quotient from the setpoint value of the quotient, this can be an indication of the degradation of the hydrogen carrier material, in particular due to unsuitable process conditions and/or the use of an incorrect catalyst. In particular, due to this mathematical correlation, i.e. the quotient formation, a reference determination of the degradation of the hydrogen carrier material prior to each method step is not necessary, i.e. dispensable. Quality monitoring is thus simplified and possible in an uncomplicated manner.

In particular, it has been found that an average value for the proportion of by-product concentration per storage cycle can be calculated from the determined proportion of by-product c_{NP} and the cycle number i calculated from the amount of indicator material c_{T}. This calculated average value can be compared with a limit value, a maximum permissible value for the proportion of by-product per storage cycle Δc_{NP,max}. This makes it possible to determine possible degradation of the hydrogen carrier material and thus make a statement about the quality of the hydrogen carrier material.

In particular, it is possible to determine the change in by-product concentration in the preceding cycle Δc_{NP,i} in particular assuming a constant increase in concentration of the indicator material in the preceding storage cycle and a constant increase in by-product concentration in the preceding storage cycle

(i−1). The constant by-product concentration increase Δc_{NP,i} can accordingly serve as a quality parameter to verify the correct operation of a system. A deviation of the measured by-product concentration increase from an assumed constant by-product concentration increase could be an indication of incorrect process conditions. The possibilities for process monitoring, and in particular for monitoring the quality of the method, are thus extended.

$$Δ {c}_{N P , i} = {c}_{N P} - ( Δ {c}_{NP , soll} \cdot ( \frac{{c}_{T}}{Δ {c}_{T}} - 1 ) )$$

The method enables an advantageous, in particular integrated use of the indicator material. In particular, the functionality of the method is thereby expanded. It is not only possible to determine the age of the hydrogen carrier material, but also its quality and in particular to show the dependence of the number of cycles on the by-product formation, which can in particular serve as direct verification of the quality of the system operation. Otherwise, this quality verification would have to be carried out in an elaborate manner by means of a measurement prior to and after dehydrogenation, which is costly. The additional effort for quality determination is low. The integrated quality determination is not costly. In particular, it has been recognized that the indicator material formed as a by-product in a chemical reaction can be formed in particular in such a targeted manner that the amount of the by-product can form the defined amount of the indicator material. For this purpose, a catalyst intended for the formation of the by-product may be provided, which is arranged in particular within the hydrogenation reactor and/or the dehydrogenation reactor. This catalyst is in particular bifunctional. The bifunctional catalyst can catalyze the main reaction, i.e. the hydrogenation reaction and/or the dehydrogenation reaction, and the formation of the by-product. However, it is also possible to use two different catalysts for the main reaction and for the formation of the by-product.

In principle, it is also conceivable that the by-product is formed outside the hydrogenation reactor and/or outside the dehydrogenation reactor, in particular in a separate by-product reactor. In this case, the catalyst provided for this purpose is arranged in the separate reactor for by-product formation.

It is particularly advantageous if the comparison with the maximum permissible value of the proportion of the by-product can be used for a qualitative evaluation and in particular for a change in the reaction conditions.

In particular, it has been found that by-product formation and/or degradation according to the invention causes contamination of the hydrogen carrier material, thereby reducing the purity of the hydrogen carrier material. In this respect, the state of the hydrogen carrier material, i.e. the number of storage cycles, can be determined by determining the purity of the hydrogen carrier material. The determination of the state of the hydrogen carrier material on the basis of the purity or the amount of impurities requires in particular that the formation rate of by-products and/or degradations is constant with each storage cycle.

It has been found that the determination of the proportion of the indicator material in the mixture in the storage cycle, in particular prior to the release and prior to the charging of the hydrogen carrier material is carried out according to the invention, i.e. twice per cycle, when the indicator material is identical to the by-product formed. When the proportion of the indicator material is determined twice, it is then possible to determine the degradation of the hydrogen carrier material in dependence on the number of cycles, in particular directly.

A method, in which the determination of the proportion of the indicator material in the mixture is carried out by means of a determination unit with a measuring method, in particular for determining physicochemical properties of the indicator material, comprising nuclear magnetic resonance spectroscopy, gas chromatography, liquid chromatography, UV-visible spectroscopy, infrared spectroscopy, Raman spectroscopy, FTIR spectroscopy, refractometry and/or density measurement, enables the direct and simplified determination, in particular measurement, of the proportion of the indicator material and/or a by-product.

A use of a hydrogen carrier material as an indicator material for determining a state of a further hydrogen carrier material, in particular its number of storage cycles and/or its degradation has substantially the advantages of the method, in which a second hydrogen carrier material different from the hydrogen carrier material is added as indicator material, which is in particular a substrate of cyclic hydrocarbon compounds, in particular of dibenzyltoluene, benzyltoluene, toluene, N-ethylcarbazole, fluorene, methylfluorene, naphthalene, anthracene, diphenylmethane, biphenyl and/or indoline and/or mixtures of these hydrocarbon compounds, and/or completely or partially hydrogenated compounds thereof, in particular of at least one isomer of the said compounds. Surprisingly, it has been found that an indicator material, in particular a hydrogen carrier material, can be used. The hydrogen carrier material used as indicator material is different from another hydrogen carrier material whose state is to be determined. The indicator material is in particular a substrate of cyclic hydrocarbon compounds, in particular of dibenzyltoluene, benzyltoluene, toluene, N-ethylcarbazole, fluorene, methylfluorene, indoline, naphthalene, anthracene, diphenylmethane and/or biphenyl, and/or completely or partially hydrogenated compounds thereof, in particular from at least one isomer of the said compounds. The state of the hydrogen carrier material is understood in particular as the number of storage cycles for the hydrogen carrier material and/or its age.

A use of an indicator material formed by a selective conversion of a hydrogen carrier material for determining a state of the hydrogen carrier material, in particular its number of storage cycles and/or its degradation has substantially the advantages of the method, in which the indicator material is formed by a selective conversion of the hydrogen carrier material, in particular a dehydrocyclization of the hydrogen carrier material, in particular a dehydrogenation of benzyltoluene to methylfluorene. The indicator material is formed by selective conversion of the hydrogen carrier material, in particular by dehydrocyclization of the hydrogen carrier material, in particular by dehydrogenation of benzyltoluene to form methylfluorene. The state of the hydrogen carrier material is understood to be in particular the number of storage cycles for the hydrogen carrier material and/or its age.

A use of an indicator material formed as a by-product, in particular of a dehydrogenation reaction of hydrogen carrier material, for determining a state of the hydrogen carrier material, in particular its number of storage cycles and/or its degradation has substantially the advantages of the method, in which the indicator material is formed as a by-product of a chemical reaction, in particular the dehydrogenation reaction of the hydrogen carrier material. The indicator material is formed as a by-product of a chemical reaction, in particular the dehydrogenation reaction of the hydrogen carrier material. The condition of the hydrogen carrier material is understood to be in particular the number of storage cycles for the hydrogen carrier material and/or its age.

A system according to the invention has substantially the advantages of the method according to the invention, to which reference is hereby made.

Both the features indicated above and the features indicated in the embodiment example of a system according to the invention are each suitable, either on their own or in combination with each other, for further embodying the subject-matter according to the invention. The respective combinations of features do not represent any restriction with regard to the further embodiments of the subject-matter of the invention, but are essentially merely exemplary in character.

Further features, advantages and details of the invention will be apparent from the following description of an embodiment example based on the drawing.

### BRIEF DESCRIPTION OF THE DRAWING

FIG. 1 shows a schematic representation of a system according to the invention.

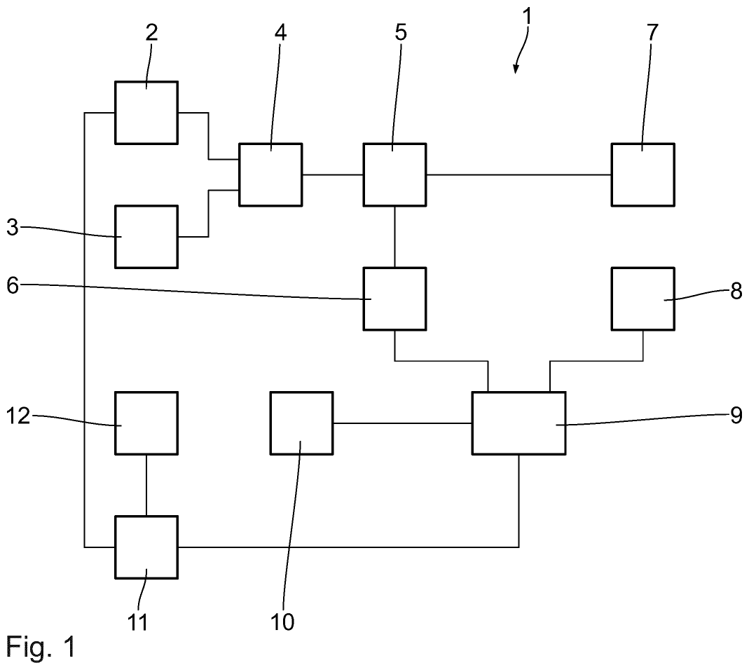

### DESCRIPTION OF THE PREFERRED EMBODIMENT

A system marked 1 as a whole comprises a first storage container 2 in which hydrogen carrier material that is at least partially charged with hydrogen is stored. The hydrogen carrier material at least partially charged with hydrogen is referred to as LOHC-H. The system 1 further comprises a second storage container 3 in which an indicator material is stored. The two storage containers 2, 3 are connected to a mixing unit 4 which is connected to a dehydrogenation reactor 5 which is a discharge unit for releasing hydrogen from the at least partially charged hydrogen carrier material LOHC-H. The mixing unit 4 may have its own container. However, the mixing unit 4 can also exist purely functionally and in particular be arranged to be integrated in the dehydrogenation reactor 5. The mixing unit 4 comprises in particular at least one dosing pump which is used for the dosed addition of the indicator material to the hydrogen carrier material.

The dehydrogenation reactor 5 is connected to a third storage container 6 in which the hydrogen carrier material LOHC-D at least partially discharged in the dehydrogenation reactor 5 can be stored. A hydrogen utilization unit 7 is further connected to the dehydrogenation reactor 5, in which the hydrogen gas released in the dehydrogenation reactor 5 can be utilized. The hydrogen utilization unit 7 is, for example, a fuel cell or a hydrogen combustion engine.

The third storage container 6 and a fourth storage container 8 are connected to a hydrogenation reactor 9, which forms a charging unit for charging the at least partially discharged hydrogen carrier material LOHC-D with hydrogen. As with the dehydrogenation reactor 5, a mixing unit not shown can also be connected upstream of the hydrogenation reactor 9. In this case, this mixing unit is arranged between the storage containers 6, 8 and the hydrogenation reactor 9. This mixing unit can also be configured to be integrated in the hydrogenation reactor 9. The fourth storage container 8 is essentially identical to the second storage container 3. Indicator material is stored in the fourth storage container 8.

A hydrogen source 10 is connected to the hydrogenation reactor 9 to supply hydrogen gas to be chemically bound to the hydrogen carrier material LOHC-D in the hydrogenation reactor 9.

A determination unit 11 is connected to the hydrogenation reactor 9. The determination unit 11 is in particular arranged between the hydrogenation reactor 9 and the first storage container 2. In particular, the determination unit 11 is fluidically connected to the hydrogenation reactor 9 and/or to the first storage container 2. In particular, the fluidic connection of the determination unit 11 to the hydrogenation reactor 9 and/or to the first storage container 2 is made by means of mobile storage containers, in particular tank vehicles, in particular tank trucks. In principle, a line connection is also conceivable.

It is advantageous if the hydrogenation reactor 9 and the dehydrogenation reactor 5 are arranged at different, in particular spatially distant locations. The hydrogenation reactor 9 is arranged in particular at an energy-rich location where there is a surplus of energy and in particular energy is available at comparatively favourable conditions. The dehydrogenation reactor 5 is arranged in particular at a low-energy location where there is a demand for energy and energy is available in particular at cost-intensive conditions.

It is advantageous if the hydrogenation reactor is arranged at a particularly high-energy, in particular central, location. In particular, the hydrogenation reactor 9 is connected to a plurality of dehydrogenation reactors 5. In this case, it is advantageous if the addition of the indicator material to the hydrogen carrier material takes place at the central high-energy location of the hydrogenation. In particular, it is unnecessary to provide indicator material separately at the dehydrogenation locations. The effort for carrying out the method, in particular the dehydrogenation, is thus reduced. This method is particularly advantageous if the indicator material is added separately and is not formed by a chemical reaction during the process.

The determination unit 11 can also be arranged along the fluid lines of the system 1 at any other location within the circuit between the first storage container 2, the dehydrogenation reactor 5, the third storage container 6 and the hydrogenation reactor 9. In particular, it is conceivable to provide several, in particular differently configured, determination units 11.

The determination unit 11 comprises in particular at least one sensor for determining and in particular measuring a proportion of the indicator material in a mixture of the indicator material and the hydrogen carrier material.

The determination unit 11 is in signal connection with an analysis unit 12. The analysis unit 12 serves to determine the state of the hydrogen carrier material LOHC and in particular to determine the number of storage cycles for the hydrogen carrier material and in particular to determine the quality of the hydrogen carrier material. The signal connection between the determination unit and the analysis unit can be wired or wireless. In particular, it is conceivable that the analysis unit 12 is configured to be integrated in the determination unit. It is also conceivable that the analysis unit 12 is designed externally and in particular remotely in addition to or as an alternative to the integrated design, in particular in a central regulating unit of the system 1 that is not shown in more detail.

A method for determining the state of the hydrogen carrier material by means of the system 1 is explained in more detail below. The hydrogen carrier material in the at least partially charged form is perhydrobenzyltoluene, which is dehydrogenated in the dehydrogenation reactor 5 by means of a catalyst. In this case, 0.3% platinum dispersed on porous aluminium oxide is used for the catalyst.

During the dehydrogenation of LOHC-H, an amount of methylfluorene is selectively formed from the carrier molecule of LOHC-H benzyltoluene by means of the catalyst. Methylfluorene is a by-product and can be used as an indicator material. In this embodiment, the mixing unit 4 is configured to be integrated in the dehydrogenation reactor 5. In this embodiment, in particular, the second storage container 3 is not required for storing the indicator material, since the indicator material is not added separately, but is formed by a chemical process in the dehydrogenation reactor 5.

A cycle of the storage process comprises charging the LOHC-H with hydrogen in the hydrogenation reactor 9, intermediate storage of the charged hydrogen carrier material LOHC-H in the first storage container 2, release of hydrogen gas from the charged hydrogen carrier material LOHC-H in the dehydrogenation reactor 5 and intermediate storage of the discharged hydrogen carrier material LOHC-D in the third storage container 6.

It is essential that the amount of by-product formed, i.e. indicator material, is constant in each cycle. The amount of indicator material, i.e. the proportion of indicator material in a mixture of hydrogen carrier material and indicator material, is measured in the determination unit 11 and the number of storage cycles for the hydrogen carrier material is calculated from the measured value in the analysis unit 12, in particular by dividing the determined proportion of indicator material by the added defined amount of indicator material per storage cycle. In this case, the determination unit 11 may advantageously be arranged at the location of dehydration, i.e. at the low-energy location. Degraded material could be sorted out immediately after the measurement and transported to a preparation of the hydrogen carrier material.

An advantage of this method is that methyl fluorene can be used as a by-product, in particular also for determining the quality of the hydrogen carrier material, in particular by comparing the proportion of the by-product, i.e. the proportion of the indicator material, with a maximum admissible value for the by-product. This comparative check takes place in particular in the analysis unit 12. In the analysis unit 12, it can also be checked whether the total amount of the by-product exceeds a defined limit value. In this case, this would be an indication of a degradation of the hydrogen carrier material. A replacement of the hydrogen carrier material could be initiated or at least prepared.

Another advantage of this method is that methyl fluorene itself forms a second hydrogen carrier material LOHC*, which is different from the hydrogen carrier material LOHC. Advantageously, LOHC* can be cyclically hydrogenated and dehydrogenated, thus maintaining the storage capacity of the mixture of hydrogen carrier material and indicator material.

In the following, a variant of a method for determining the state of the hydrogen carrier material by means of the system 1 is explained, wherein perhydrobenzyltoluene and the same catalyst are used as hydrogen carrier material in the charged form analogously to the previous example.

It has been found that by-products are formed during the dehydrogenation which contain neither benzyltoluene nor dibenzyltoluene. Therefore, dibenzyltoluene (DBT) can be added in a defined manner as an indicator material, in particular in small amounts, in particular at most 2.0% in relation to the volume of the hydrogen carrier material. Dibenzyltoluene is a second hydrogen carrier material LOHC* different from the hydrogen carrier material. Based on the concentration of the indicator material, the number of storage cycles for the hydrogen carrier material LOHC can be determined and ascertained in the manner described above by means of the determination unit 11 and the analysis unit 12.

Another advantage is that from the correlation of the concentration of the indicator material, i.e. dibenzyltoluene, and the concentration of the by-products, it is possible to draw conclusions about possible deviations from the previously determined theoretical degradation rate. This makes it possible to determine the quality of the hydrogen carrier material. Since dibenzyltoluene can be cyclically charged and discharged with hydrogen, the total storage capacity for the method for determining the state of the hydrogen carrier material is not impaired and is in particular maintained.

1. A method for determining a state of a hydrogen carrier material, the method comprising the steps of:
using the hydrogen carrier material in a cyclic storage process, wherein each storage cycle comprises;
charging the hydrogen carrier material with hydrogen;
releasing hydrogen from the hydrogen carrier material;
producing a mixture by adding a defined amount of an indicator material to the hydrogen carrier material;
determining a proportion of the indicator material in the mixture; and
determining the state of the hydrogen carrier material to be at least one of:
a number of storage cycles for the hydrogen carrier material on the basis of the determined proportion of the indicator material and
a degradation of the hydrogen carrier material on the basis of the determined proportion of the indicator material.

2. The method according to claim 1, wherein the indicator material is at least one of added during and after releasing the hydrogen carrier material.

3. The method according to claim 1, wherein an averaged proportion of the indicator material is determined for a mixture of different batches of the hydrogen carrier material.

4. The method according to claim 1, wherein the added amount of indicator material per storage cycle is at most 2.0% relative to the hydrogen carrier material.

5. The method according to claim 1, wherein a second hydrogen carrier material different from the hydrogen carrier material is added as indicator material, which is a substrate of cyclic hydrocarbon compounds.

6. The method according to claim 1, wherein the indicator material is formed during a storage cycle.

7. The method according to claim 6, wherein the indicator material is formed by a selective conversion of the hydrogen carrier material.

8. The method according to claim 7, further comprising the use of a heterogeneous catalyst.

9. The method according to claim 6, wherein the indicator material is formed as a by-product of a chemical reaction.

10. The method according to claim 1, further comprising determining a proportion of a by-product in the mixture by means of a determination unit.

11. The method according to claim 10, wherein for determining the degradation of the hydrogen carrier material on the basis of the determined proportion of the by-product, a comparison is made with an admissible maximum value of the proportion of the by-product per storage cycle.

12. The method according to claim 1, wherein the determination of the proportion of indicator material in the mixture in each storage cycle is carried out prior to release and prior to loading of the hydrogen carrier material.

13. The method according to claim 1, wherein the determination of the proportion of the indicator material in the mixture is carried out by means of a determination unit with a measuring method.

14. A process of utilizing a hydrogen carrier material as an indicator material for determining a state of a further hydrogen carrier material, which is at least one of a number of storage cycles and a degradation.

15. A process of utilizing an indicator material formed by a selective conversion of a hydrogen carrier material for determining a state of the hydrogen carrier material, which is at least one of a number of storage cycles and a degradation.

16. A process of utilizing an indicator material formed as a by-product of a dehydrogenation reaction of hydrogen carrier material, for determining a state of the hydrogen carrier material, which is at least one of a number of storage cycles and a degradation.

17. A system for determining a state of a hydrogen carrier material, the system comprising:
a charging unit for charging the hydrogen carrier material with hydrogen;
a discharging unit for releasing hydrogen from the hydrogen carrier material;
a mixing unit for producing a mixture by adding a defined amount of an indicator material to the hydrogen carrier material;
a determination unit for determining a proportion of the indicator material in the mixture; and
an analysis unit for determining, as a state of the hydrogen carrier material, at least one of a number of storage cycles for the hydrogen carrier material on the basis of the determined proportion of the indicator material and a degradation of the hydrogen carrier material on the basis of the determined proportion of the indicator material.

18. The method according to claim 1, wherein the indicator material is added before charging of the hydrogen carrier material.

19. The method according to claim 3, wherein the averaged proportion of the indicator material is determined by means of exactly one measurement of the averaged proportion of the indicator material.

20. The method according to claim 5, wherein the second hydrogen carrier material is a substrate of at least one of dibenzyltoluene, benzyltoluene, toluene, N-ethylcarbazole, fluorene, methylfluorene, naphthalene, anthracene, diphenylmethane, biphenyl and indoline and mixtures of these hydrocarbon compounds, and one of completely and partially hydrogenated compounds thereof.

21. The method according to claim 7, wherein the hydrogen carrier material is a dehydrogenation of benzyltoluene to methylfluorene.

22. The method according to claim 10, wherein during the release of hydrogen from the hydrogen carrier material a proportion of the by-product is formed for each storage cycle.

23. The method according to claim 13, wherein the determination of the proportion of the indicator material in the mixture is carried out by means of determining physicochemical properties of the indicator material, comprising nuclear magnetic resonance spectroscopy, gas chromatography, liquid chromatography, UV-visible spectroscopy, infrared spectroscopy, Raman spectroscopy, FTIR spectroscopy, refractometry and/or density measurement.
